(19) United States
(12) Patent Application Publication
(10) Pub. No.: US 2026/0183731 A1
(43) Pub. Date: Jul. 2, 2026

(54) AMMONIA DECOMPOSITION REACTOR

(71) Applicant: KOREA INSTITUTE OF SCIENCE AND TECHNOLOGY, Seoul (KR)

(72) Inventors: Hyuntae SOHN, Seoul (KR); Suk Woo NAM, Seoul (KR); Yongmin KIM, Seoul (KR); Hyangsoo JEONG, Seoul (KR); Keunsoo KIM, Seoul (KR); Sung Pil YOON, Seoul (KR); Sun-Hee CHOI, Seoul (KR); Yeong Cheon KIM, Seoul (KR)

(21) Appl. No.: 19/097,228

(22) Filed: Apr. 1, 2025

(30) Foreign Application Priority Data
Dec. 26, 2024 (KR) 10-2024-0197117

(51) Int. Cl. B01J 8/04; C01B 3/04

(52) U.S. Cl. CPC B01J 8/0492; B01J 8/0484; B01J 8/0496; C01B 3/047; B01J 2208/00407

(57) ABSTRACT

This specification discloses an ammonia decomposition reactor comprising a plurality of reaction chambers, a passage, an inlet and outlet, and a plurality of flat plate-type heaters. According to the exemplary embodiments of the present invention, the hydrogen production rate can be maximized relative to the weight and volume of the system, and the heaters can be individually controlled, providing the effect of facilitating heat management.

### CROSS REFERENCE TO RELATED APPLICATION

The present application claims priority to Korean Patent Application No. 10-2024-0197117, filed on Dec. 26, 2024, the entire contents of which are hereby incorporated by this reference.

### BACKGROUND OF THE INVENTION

### Field of the Invention

This specification discloses an ammonia decomposition reactor.

### DESCRIPTION OF GOVERNMENT-SPONSORED RESEARCH

This invention was carried out with the support of Ministry of Trade, Industry and Energy under a research project of Unique Project identification number: 2410001038 and Project identification number: 00435426 titled “Development of thermal decomposition catalyst module technology with highly active non-precious metals”, as part of the research project of “Establishing a foundation for developing materials and components industry technology (R&D)” managed by Korea Planning & Evaluation Institute of Industrial Technology from Jul. 1 to Dec. 31, 2024.

### Description of the Related Art

In order to prevent abnormal climate phenomena caused by global warming, major economic countries, including South Korea, are striving to transition from a fossil fuel-based society to a renewable energy-based society for carbon neutrality. In line with this trend, hydrogen, an environmentally friendly energy source, is gaining attention. Hydrogen is gaining attention as a clean energy source because, when used in fuel cells, it undergoes a chemical reaction with oxygen to generate electricity without emitting any environmental pollutants, with the only byproduct being pure water. Depending on the production method and level of environmental friendliness, hydrogen is classified into gray hydrogen, blue hydrogen, and green hydrogen. Gray hydrogen is typically produced by catalytically reacting methane, a natural gas, with high-temperature steam to produce hydrogen. Currently, approximately 96% of the hydrogen produced is gray hydrogen. However, in case of gray hydrogen, there is an issue of carbon dioxide being emitted alongside the production of hydrogen. Blue hydrogen has the same production method as gray hydrogen, but it captures and separately stores the carbon dioxide generated during the production process, resulting in a reduction of carbon dioxide emissions compared to gray hydrogen and a higher level of environmental friendliness. However, there are limitations due to the fact that carbon dioxide cannot be completely removed. Green hydrogen is typically produced by using electrical energy obtained from renewable energy sources such as solar and wind power to electrolyze water and produce hydrogen, without emitting any carbon dioxide. As a result, it is gaining attention as the ultimate hydrogen production method for the future. Recently, in the green hydrogen production method, developments have been underway not only in renewable energy but also in hydrogen production technologies through the decomposition (reforming) of ammonia, taking into account the storage and transportation of the produced hydrogen.

The ammonia decomposition hydrogen production process is conceptually similar to steam reforming. By supplying ammonia to a catalyst layer at 600 to 800° C., hydrogen and nitrogen are obtained through a decomposition reaction. Ammonia decomposition hydrogen, similar to steam reforming hydrogen, is expected to be widely used in fuel cells for vehicles and power generation. Meanwhile, in small and medium-sized reformers, the compactness of the device is very important. For example, when installing the device in urban areas on land or using it on ships at sea, there are constraints on the installation space, which is equal to or less than a certain height and area. In this case, the compact design of the equipment is very important. In particular, there is a need for the development of a system that drastically reduces the size of the ammonia decomposition reactor while maintaining the heat transfer area, thereby maximizing overall efficiency.

### SUMMARY OF THE INVENTION

An object of the present invention is to provide an ammonia decomposition reactor that drastically reduces the size of the ammonia decomposition reactor while maintaining the heat transfer area, thereby maximizing overall efficiency.

In one aspect, exemplary embodiments of the present invention provide an ammonia decomposition reactor including: a plurality of reaction chambers including an ammonia decomposition catalyst; a passage that allows fluid communication within the reaction chambers; an inlet and outlet formed at each of both end reaction chambers through which the fluid communicates; and a plurality of flat plate-type heaters, formed at both ends of the reaction chamber and between the reaction chambers, which are individually controlled.

According to the exemplary embodiments of the present invention, the hydrogen production rate can be maximized relative to the weight and volume of the system, and the heaters can be individually controlled, providing the effect of facilitating heat management.

### BRIEF DESCRIPTION OF THE DRAWINGS

FIG. 1 is a schematic view illustrating an ammonia decomposition reactor according to an embodiment of the present invention.

FIG. 2 is a photograph illustrating the ammonia decomposition reactor according to an embodiment of the present invention.

FIG. 3 is a graph illustrating the ammonia decomposition performance evaluation results for each outlet temperature of the ammonia decomposition reactor according to an embodiment of the present invention.

FIG. 4 is a graph illustrating the ammonia decomposition performance evaluation results for each position of the ammonia decomposition reactor according to an embodiment of the present invention.

FIG. 5 is a graph illustrating the ammonia decomposition performance evaluation results for each feeding rate of ammonia gas of the ammonia decomposition reactor according to an embodiment of the present invention.

FIG. 6 is a graph illustrating the ammonia decomposition performance evaluation results for each feeding rate of ammonia gas of the ammonia decomposition reactor according to an embodiment of the present invention.

### DETAILED DESCRIPTION OF THE INVENTION

The terms used in the present specification are selected from general terms currently widely used in the art in consideration of functions in the present disclosure, but the terms may vary according to the intention of those skilled in the art, precedents, or new technology in the art. Further, specified terms are selected arbitrarily by the applicant, and in this case, the detailed meaning thereof will be described in the detailed description of the invention. Thus, the terms used in the present specification should be defined based on not simple names but the meaning of the terms and the overall description of the present disclosure.

Unless otherwise defined, all terms used herein, including technical or scientific terms, have the same meaning as commonly understood by those skilled in the art to which the present disclosure pertains. The terms which are commonly understood should be interpreted as having meanings consistent with meanings in the context of related technologies and should not be interpreted as ideal or excessively formal meanings unless explicitly defined in the present disclosure.

Numerical value ranges are inclusive of the values defined in the present disclosure. Every maximum numerical limitation given throughout the present specification includes every lower numerical limitation, as if such lower numerical limitations were expressly written. Every minimum numerical limitation given throughout the present specification includes every higher numerical limitation, as if such higher numerical limitations were expressly written. Every numerical limitation given throughout the present specification will include every better numerical range within the broader numerical range, as if the narrower numerical limitations were expressly written.

As used in the present specification, the words “comprising”, “having”, “including” are inclusive or open-ended and do not exclude additional unrecited elements or method steps. The term “or combinations thereof” used in the present specification refers to all permutations and combinations of the items listed preceding the term. For example, “A, B, C, or combinations thereof” is intended to be A, B, C, AB, AC, BC, or ABC, and to include at least one of BA, CA, CB, CBA, BCA, ACB, BAC or CAB, where order is important in a particular context. With the example above, “A, B, C, or combinations thereof” may include combinations containing repetitions of one or more items or terms, such as BB, AAA, MB, BBC, AAABCCCC, CBBAAA, CABABB, and the like. Those skilled in the art will understand that there is typically no limit to the number of items or terms in any combination, unless the context clearly indicates otherwise.

Hereinafter, exemplary embodiments of the present disclosure will be described in detail with reference to the drawings. However, it is apparent that the present disclosure is not limited by the following embodiments.

### Ammonia Decomposition Reactor

In one aspect, exemplary embodiments of the present invention provide an ammonia decomposition reactor including: a plurality of reaction chambers including an ammonia decomposition catalyst; a passage that allows fluid communication within the reaction chambers; an inlet and outlet formed at each of both end reaction chambers through which the fluid communicates; and a plurality of flat plate-type heaters, formed at both ends of the reaction chamber and between the reaction chambers, which are individually controlled.

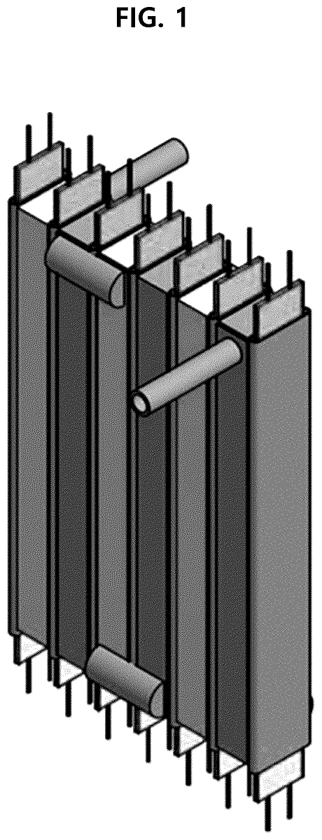

FIG. 1 is a schematic view illustrating an ammonia decomposition reactor according to an embodiment of the present invention. The inventors of the present invention have completed the invention by realizing that when a plurality of ammonia decomposition devices are configured with heaters that are individually controlled, the hydrogen production rate can be maximized relative to the weight and volume of the system, and the individual control of the heaters facilitates heat management.

The ammonia decomposition reactor according to an embodiment of the present invention has a structure in which the heater and the reaction chamber are in contact but separated from the reactants, rather than having a heating element coexisting inside the reactor. This structure has the advantage of preventing corrosion caused by the reactants and ensuring good heat transfer efficiency. Moreover, temperature control can be precisely applied at each position through which the reactants pass, allowing the overall system efficiency to be maximized. In addition, the ammonia decomposition reactor according to an embodiment of the present invention has the advantages of fast operation time and compact device due to the shape of the reactor and the heating method as described above.

The ammonia decomposition reactor according to an embodiment of the present invention can be applied to various fields. More specifically, it can be applied in starting devices for fuel cells, engines and turbines that use ammonia, in devices for safely processing ammonia after ammonia adsorption and removal, and in compact reaction devices for endothermic reactions.

In relation to the starting devices for fuel cells, engines and turbines that use ammonia, ammonia itself is difficult to ignite. However, by partially decomposing ammonia and supplying it along with ammonia, combustion becomes easier, allowing for the rapid supply of combustion gas during the startup of fuel cells, engines, and turbines. That is, when ammonia is used in a fuel cell, partially decomposed ammonia gas is supplied to a burner along with ammonia, allowing for a quick startup of the fuel cell. Similarly, by supplying partially decomposed ammonia gas to engines or turbines, the startup can be quickly carried out.

In relation to devices for safely processing ammonia after ammonia adsorption and removal, to ensure the safety of systems using ammonia, an ammonia adsorption and removal system is used in the event of ammonia leakage. When the adsorbed ammonia needs to be desorbed later and an adsorbent is to be regenerated, it is very safe to completely decompose the desorbed ammonia, convert it into hydrogen and nitrogen, and then combust it for removal. Therefore, the flat plate-type reactor of the present invention may be used for this purpose. In addition, ammonia is decomposed to supply hydrogen used in fuel cells from ammonia, but in case of low-temperature fuel cells, the ammonia concentration needs to be reduced to 10 ppb or less before being supplied. For this purpose, the flat plate-type reactor of the present invention may be used to safely process the ammonia that is adsorbed and removed when an adsorption system is used.

In relation to compact reaction devices for endothermic reactions, the reactor may be used as a very small-volume reactor applicable to gas-phase, liquid-phase, and solid-phase reactions that require endothermic processes, such as ammonia decomposition, liquid organic hydrogen carrier (LOHC) dehydrogenation, and methanol reforming reactions.

According to an embodiment of the present invention, the ammonia decomposition reactor according to an embodiment of the present invention may be applied to reforming reactions of methane, reforming reactions of methanol, decomposition reactions of ammonia, and dehydrogenation reactions of liquid organic hydrogen carriers (LOHC). As an example, the decomposition reaction of ammonia is as follows in Reaction Formula 1.

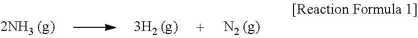

According to an embodiment of the present invention, the reaction chamber is made of a metal substrate. The metal substrate is at least one selected from the group consisting of copper (Cu), aluminum (Al), tungsten (W), iron (Fe), Inconel, and combinations thereof.

According to an embodiment of the present invention, a coating layer is further included formed on the inside the reaction chamber. The coating layer may further include a catalyst for the ammonia decomposition reaction. The catalyst may be applied to the coating layer to form a catalyst layer.

According to an embodiment of the present invention, the catalyst may include at least one catalyst metal selected from the group consisting of ruthenium (Ru), lanthanum (La), platinum (Pt), palladium (Pd), nickel (Ni), iron (Fe), cobalt (Co), and combinations thereof.

According to an embodiment of the present invention, the passage that allows the fluid within the reaction chamber to communicate is formed in a crossing manner, guiding the flow of the fluid in a zigzag shape. By guiding the flow of the fluid in a zigzag shape, the reaction may be made to occur evenly. According to an embodiment of the present invention, the passage that allows the fluid within the reaction chamber to communicate is formed by a separate internal passage or by a partition wall between the reaction chambers.

According to an embodiment of the present invention, the flat plate-type heater is a ceramic heater. More specifically, the ceramic heater is a conductive ceramic heater, which may include a heating element that converts electrical energy into thermal energy through the heating section of a ceramic resistor that has electrical resistance.

According to an embodiment of the present invention, the flat plate-type heater is configured with two heaters per formed section, resulting in a total of 2n+2 heaters for the number (n) of reaction chambers. For example, when there are 6 reaction chambers, the flat plate-type heater is formed with 14 heaters. The ammonia decomposition reaction is an endothermic reaction with a very high heat absorption, and in a conventional structure of catalyst decomposition reactors, a temperature drop occurs within the reactor, causing a rapid decrease in catalyst activity. Therefore, in a catalytic decomposition reactor where the ammonia decomposition reaction occurs due to catalyst activity, ammonia is not decomposed, and a large amount of unconverted ammonia remains. Accordingly, the inventors of the present invention have provided a plurality of flat plate-type heaters for temperature control for each reaction position.

According to an embodiment of the present invention, the temperature of the outlet is 500° C. to 600° C. More specifically, the temperature of the outlet may be 500° C. or more, 510° C. or more, 520° C. or more, 530° C. or more, 540° C. or more, 550° C. or more, 560° C. or more, 570° C. or more, or 575° C. or more, and 600° C. or less, 590° C. or less, 580° C. or less, or 570° C. or less, but is not limited thereto.

According to an embodiment of the present invention, the feeding rate of ammonia gas introduced into the inlet is 1 to 15 L min⁻¹. More specifically, the feeding rate of ammonia gas introduced into the inlet may be 1 L min⁻¹ or more, 1.5 L min⁻¹ or more, 2 L min⁻¹ or more, 2.5 L min⁻¹ or more, 3 L min⁻¹ or more, and 15 L min⁻¹ or less, 14 L min⁻¹ or less, 13 L min⁻¹ or less, 12 L min⁻¹ or less, 11 L min⁻¹ or less, 10 L min⁻¹ or less, 9 L min⁻¹ or less, 8 L min⁻¹ or less, 7 L min⁻¹ or less, 6 L min⁻¹ or less, 5 L min⁻¹ or less, 4 L min⁻¹ or less, or 3 L min⁻¹ or less, but is not limited thereto.

According to an embodiment of the present invention, the total volume of the plurality of reaction chambers is 10 to 200 cm³. More specifically, the total volume of the plurality of reaction chambers may be 10 cm³ or more, 20 cm³ or more, 30 cm³ or more, 40 cm³ or more, 50 cm³ or more, 60 cm³ or more, 70 cm³ or more, 80 cm³ or more, 90 cm³ or more, 100 cm³ or more, 110 cm³ or more, or 117 cm³ or more, and 200 cm³ or less, 190 cm³ or less, 180 cm³ or less, 170 cm³ or less, 160 cm³ or less, 150 cm³ or less, 140 cm³ or less, 130 cm³ or less, 120 cm³ or less, or 117 cm³ or less, but is not limited thereto.

### Examples

Hereinafter, the present disclosure will be described in detail by examples. However, the following examples are only examples to help the overall understanding of the present disclosure, and the content of the present disclosure is not limited to the following examples.

### <Manufacturing Example> Manufacturing of Ammonia Decomposition Reactor

Six cuboid-shaped reaction chambers made of stainless steel SUS316L were welded together, and an internal passage made of the same material as the reaction chambers was also welded to allow the fluid to communicate. One ammonia gas inlet and one outlet after the reaction were each formed. Meanwhile, the reaction chamber was configured to allow flat plate-type conductive ceramic heaters to be mounted on the outside thereof and at each joint surface, and a total of 14 heaters were mounted. Inside the reaction chamber, a 1.8 mm spherical alumina oxide (Al₂O₃) pellet containing 2 wt % ruthenium (Ru) and 2 wt % potassium (K) as catalysts, was filled.

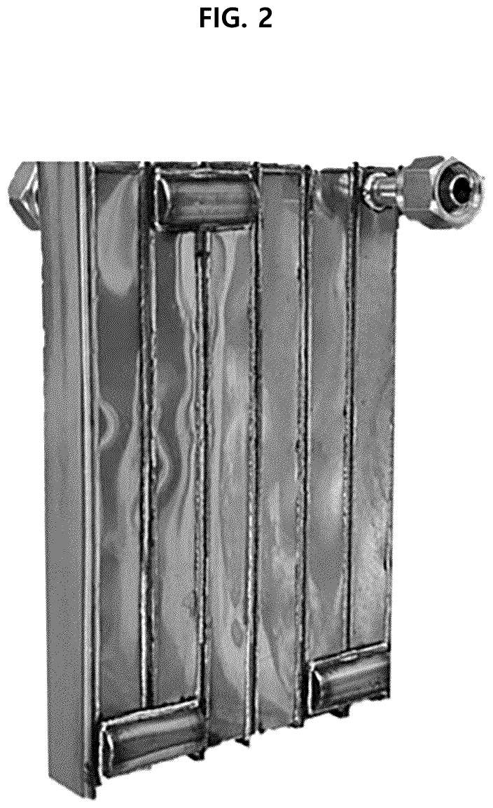

FIG. 2 is a photograph illustrating the ammonia decomposition reactor according to an embodiment of the present invention. The internal volume of the manufactured reactor is 117 cm³, the weight of the catalyst filled inside is 70 g, and the total weight of the reactor, including the catalyst, is 317 g.

### <Experimental Example 1> Evaluation of Ammonia Decomposition Performance for Each Outlet Temperature of Reactor

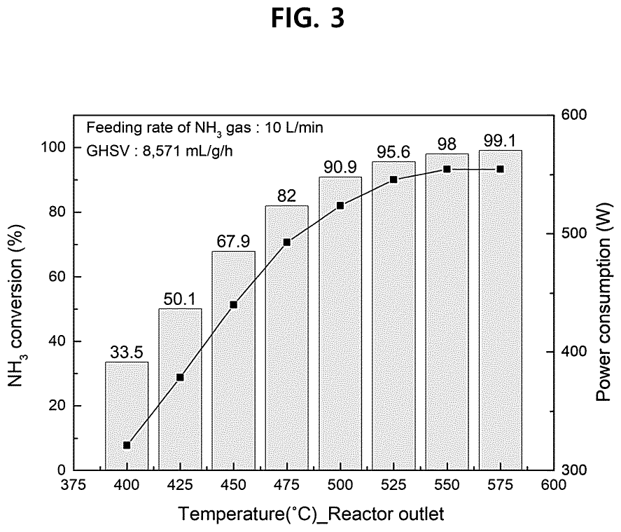

The ammonia decomposition performance of the reactor was evaluated for each outlet temperature, with a feeding rate of 10 L min⁻¹ for the ammonia gas introduced into the reactor. More specifically, the ammonia decomposition conversion rate and power consumption were measured according to the outlet temperature of the reactor. FIG. 3 is a graph illustrating the ammonia decomposition performance evaluation results for each outlet temperature of the ammonia decomposition reactor according to an embodiment of the present invention. The energy efficiency (%) of the reactor was calculated according to Equation 1.

$$Reactor energy efficiency ( \% ) = \frac{Produced {H}_{2} lower heating value ( MJ )}{Input {NH}_{3} lower heating value ( MJ ) + Power consumption ( MJ )} \times 100$$

From FIG. 3, it was confirmed that when the outlet temperature of the reactor is 575° C., the energy efficiency of the reactor reaches 90.7%.

### <Experimental Example 2> Evaluation of Ammonia Decomposition Performance for Each Position of Reactor

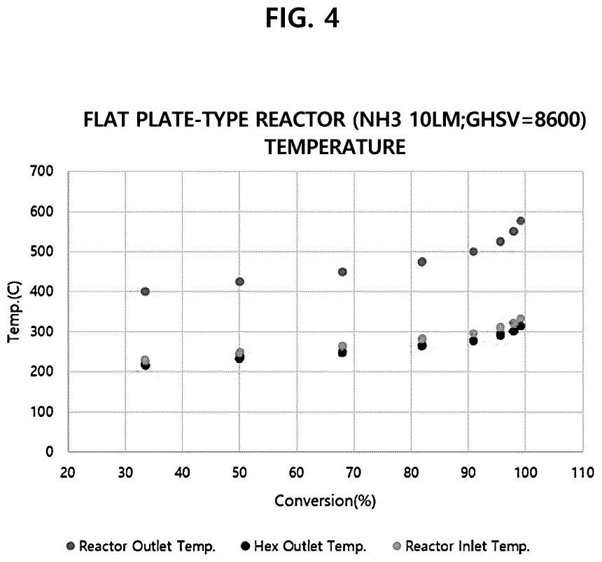

The ammonia decomposition performance for each position of the reactor was evaluated with a feeding rate of 10 L min⁻¹ for the ammonia gas introduced into the reactor and a gas hourly space velocity (GHSV) of 8,600 mL g⁻¹ hr⁻¹. More specifically, the ammonia decomposition conversion rate was measured according to the reactor outlet temperature, the heater outlet temperature (heat exchanger outlet temperature), and the reactor inlet temperature. FIG. 4 is a graph illustrating the ammonia decomposition performance evaluation results for each position of the ammonia decomposition reactor according to an embodiment of the present invention.

From FIG. 4, it was confirmed that when the reactor outlet temperature, heater outlet temperature, and reactor inlet temperature are 550° C., 302° C., and 322° C., respectively, the ammonia decomposition conversion rate reaches 97.86%.

### <Experimental Example 3> Evaluation 1 of Ammonia Decomposition Performance for Each Feeding Rate of Ammonia Gas

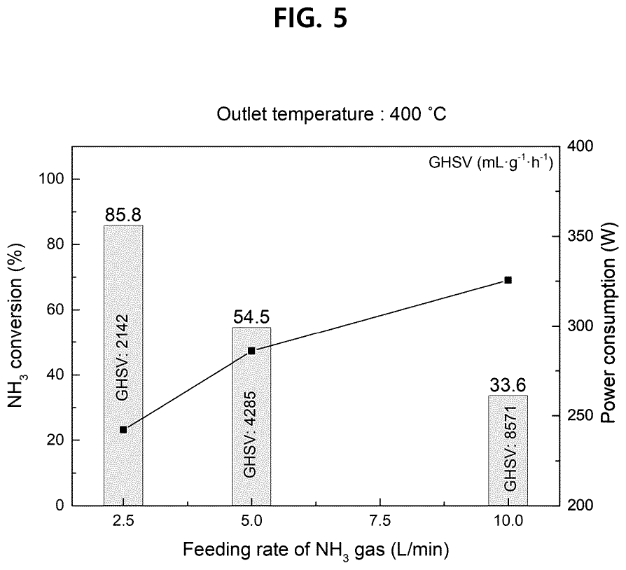

The ammonia decomposition performance was evaluated for each feeding rate of the ammonia gas introduced into the reactor. The outlet temperature of the reactor was made to be 400° C. More specifically, the ammonia decomposition conversion rate and power consumption were measured according to the outlet temperature of the reactor. FIG. 5 is a graph illustrating the ammonia decomposition performance evaluation results for each feeding rate of ammonia gas of the ammonia decomposition reactor according to an embodiment of the present invention.

From FIG. 5, it can be seen that when the outlet temperature is relatively low at 400° C., and the ammonia feeding rate is slowly set to 2.5 L min⁻¹, an ammonia decomposition rate of 85.8% is achieved with a low power consumption of 242 W.

### ≤Experimental Example 4> Evaluation 2 Of Ammonia Decomposition Performance for Each Feeding Rate of Ammonia Gas

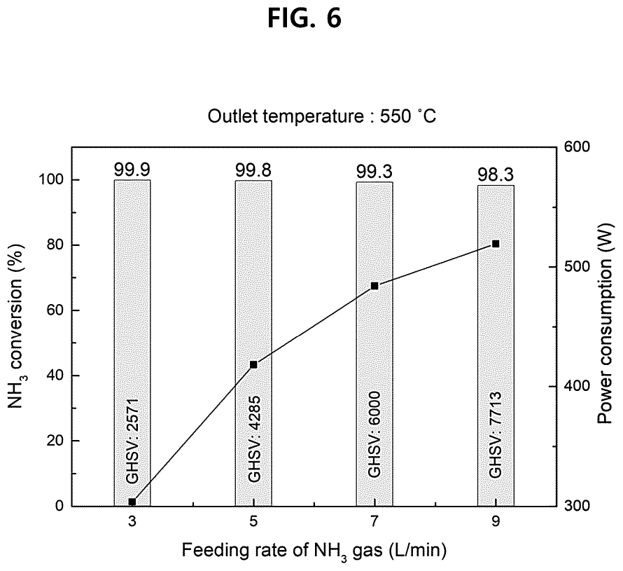

The ammonia decomposition performance was evaluated for each feeding rate of the ammonia gas introduced into the reactor. The outlet temperature of the reactor was made to be 550° C. More specifically, the ammonia decomposition conversion rate and power consumption were measured according to the outlet temperature of the reactor. FIG. 6 is a graph illustrating the ammonia decomposition performance evaluation results for each feeding rate of ammonia gas of the ammonia decomposition reactor according to an embodiment of the present invention.

From FIG. 6, it can be seen that when the outlet temperature is 550° C., ammonia gas injected at 3 L min⁻¹ can be decomposed up to 99.9% with a power consumption of 303 W, and ammonia gas injected at 9 L min⁻¹ can be decomposed up to 98.3% with a power consumption of 519 W.

While exemplary embodiments of the present disclosure have been described above with reference to the above-mentioned preferred embodiments, various modifications and alterations may be made without departing from the subject matter and the scope of the disclosure. Accordingly, the appended claims include the modifications or alterations as long as the modifications or alterations fall within the subject matter of the present disclosure.

What is claimed is:

1. An ammonia decomposition reactor, comprising:
a plurality of reaction chambers including an ammonia decomposition catalyst;
a passage that allows fluid communication within the reaction chambers;
an inlet and outlet formed at each of both end reaction chambers through which the fluid communicates; and
a plurality of flat plate-type heaters, formed at both ends of the reaction chamber and between the reaction chambers, which are individually controlled.

2. The ammonia decomposition reactor of claim 1, wherein the passage that allows fluid communication within the reaction chambers is formed in a crossing manner, guiding a flow of the fluid in a zigzag shape.

3. The ammonia decomposition reactor of claim 1, wherein the flat plate-type heater is a ceramic heater.

4. The ammonia decomposition reactor of claim 1, wherein the flat plate-type heater is configured with two heaters per formed section, and formed in a total of 2n+2 heaters for the number (n) of reaction chambers.

5. The ammonia decomposition reactor of claim 1, wherein a temperature of the outlet is 500° C. to 600° C.

6. The ammonia decomposition reactor of claim 1, wherein a feeding rate of ammonia gas introduced into the inlet is 1 to 15 L min⁻¹.

7. The ammonia decomposition reactor of claim 1, wherein a total volume of the plurality of reaction chambers is 10 to 200 cm³.
